(19) United States
(12) Patent Application Publication
(10) Pub. No.: US 2020/0226127 A1
(43) Pub. Date: Jul. 16, 2020

(54) METHOD, SYSTEM AND COMPUTER PRODUCT FOR PRESENTING LARGE DATA SETS

(71) Applicant: ForestPin (Pvt) Ltd., Colombo 5 (LK)

(72) Inventor: Varuna Parinda JAYASIRI, Colombo (LK)

(21) Appl. No.: 16/743,799

(22) Filed: Jan. 15, 2020

Related U.S. Application Data
(60) Provisional application No. 62/792,667, filed on Jan. 15, 2019.

(51) Int. Cl. G06F 16/242; G06F 17/18; G06F 16/22; G06F 16/901

(52) U.S. Cl. CPC G06F 16/244; G06F 16/9024; G06F 16/2282; G06F 17/18

(57) ABSTRACT

Conventional graphs are inadequate when the number range of interest includes positive and negative values, and these need to be visualized as three different ranges, the negative numbers only, the complete range, and the positive range of numbers. Certain example embodiments provide a new technique, referred to herein as “signed box and whisker plot”, for presenting very large datasets that include subsets of positive and negative numbers.

### CROSS REFERENCE TO RELATED APPLICATIONS

This application claims priority to U.S. Provisional Patent Application No. 62/792,667 filed on Jan. 15, 2019, which is hereby incorporated by reference in its entirety.

### TECHNICAL FIELD

Certain exemplary embodiments described herein relate generally to the presenting of large data sets.

### BACKGROUND

The analysis of large data sets has always been important in many fields including, for example, scientific research, engineering, weather/climate, medical research, financial, financial audits, etc. With the current growth in data collection and the use of “big data”, processing systems are required to process and/or present ever growing amounts of data as well as larger ranges of values captured in that data.

Several types of conventional graphs exist that focus on the complete number range and provides for visualizing all of the numbers in the range. However, conventional graphs are deficient for presenting information in certain types of number ranges. For example, conventional graphs are inadequate when the number range of interest includes positive and negative values, and these need to be visualized as three different ranges, the negative numbers only, the complete range, and the positive range of numbers. Therefore, improved techniques for presenting large data sets are desired.

### BRIEF DESCRIPTION OF THE DRAWINGS

Certain features, aspects and advantages of the embodiments described herein will be better understood from the following detailed description, including the appended drawings, in which:

FIG. 1 is a displayed plot according to certain example embodiments;

FIG. 2 illustrates certain details of the displayed plot shown in FIG. 1; and

FIG. 3 is a prior art plot for displaying a range of numbers.

FIG. 4 is a process for generating and outputting a plot according to some example embodiments.

FIG. 5 is a computing device on which some of the example embodiments can be implemented.

### DETAILED DESCRIPTION OF CERTAIN EXEMPLARY EMBODIMENTS

Example embodiments of the present invention provide for displaying, or outputting by other means, a representation of a very large set of numeric data. The example embodiments are particularly advantageous when the number range of interest includes positive and negative values, and these need to be visualized as three different ranges, the negative numbers only, the complete range, and the positive range of numbers.

In the conventional techniques, when the number range of interest includes positive and negative values, and these need to be visualized as three different ranges, three different graphs are separately generated. The three different graphs are either separately displayed, or are combined to a single graph to visualize all three ranges. The display of three separate graphs to display a single range, albeit a large range, may give rise to inefficiencies and moreover, may cause the user (e.g. analyst) to miss recognizing crucial relationships in the data. The combination of three separately generated graphs in conventional techniques also results in a presentation that is inadequate to accurately and completely present all the information in the entire range of interest.

Certain example embodiments provide a new technique, referred to herein as “signed box and whisker plot”, for presenting very large datasets that include subsets of positive and negative numbers, where three types of information (1) the negative numbers only, (2) the complete range of numbers, and (3) the positive numbers only, are presented on the same graph. The graph is drawn to make optimal use of computer displays.

The signed box and whisker plot is provided to illustrate the distribution value ranges, by showing the quartiles and the range. This shows extreme values as well as where the most numbers are. In certain aspects, the signed box and whisker plot according to certain embodiments is in the form of a combination of respective box and whisker plots for each of the negative numbers group, the positive numbers group and the aggregated numbers group arranged to partially overlap between the negative numbers group and the aggregated numbers group and to also partially overlap between the aggregated numbers group and the positive numbers group.

An example scenario in which the signed box and whisker plot of example embodiments can be particularly advantageous arises in collections of payment data. For example, an analyst dashboard can be adapted to display a signed box and whisker plot presenting the information from thousands or millions (or even more) of payment records for a credit card issuer or bank. As an example, in payments data, all payments are positive values, and the reversals of these payments are stored as negative values. When considering the range of payments, some applications may consider only the positive entries as being in the range. However, it is also important to look at the payment reversals which are negative numbers. For accurate analysis, it is important to preserve the capability to view these payments and reversals without them being combined or aggregated. It is desirable to separately analyze the negative and positive numbers.

Typically, the payment and/or accounting software applications write payment entries to files and/or database tables as positive numbers, and if one of these payments are reversed, the reversed payment is written as a negative entry. An example part of a table of payment records and reversal records is shown in Table 1 below. Persons of skill in the art will understand that Table 1 may logically represents a very small sample of a collection of payment records which may include millions or hundreds of millions payment and reversal records.

TABLE 1
Part of a table of payment records and reversal records.

| | | Reversal | | |
|---|---|---|---|---|
| Transaction | | Indicator | | Payment |
| # | Description | R-Reversals | Date | Amount $ |
| 45007 | Xxxxx | | Apr. 12, 2015 | 6,000 |
| 45008 | Xxxxy | | Apr. 12, 2015 | 6,000 |
| 45009 | Xxxxz | R | Apr. 12, 2015 | −6,000 |
| 45010 | Xxxxz | | Apr. 12, 2015 | 10,000 |

In Table 1 above, the third entry (transaction# 45009) is a reversal of the $6000 first entry (transaction# 45007). Therefore, the actual entry range that has occurred (when payments and reversals are combined) is in the range of 6,000-10,000. However, the smallest and largest number in the table ranges from −6,000 to 10,000. So the difference between the smallest and largest number is 16,000. In real terms, when payments are reconciled with any corresponding reversals, the smallest and the largest are 6,000 and 10,000 respectively and the real range is 4000. This difference between the entry-by-entry range (here 16000) and real term range (here 4000) is due to two different positive and negative number ranges co-existing in the same column amount. In order to represent an accurate and complete understanding of all aspects of amounts represented in the table, both positive and negative numbers have to be represented separately in the same graph. Similar to the above payment example, there are many other applications where both positive and negative entries are desired to be visualized separately. Conventional graph representation techniques do not support separate visualization of positive and negative numbers. The proposed technique of example embodiments includes a new graph technique conceived by the inventor to display positive numbers and reversals of these numbers on the same graph(s).

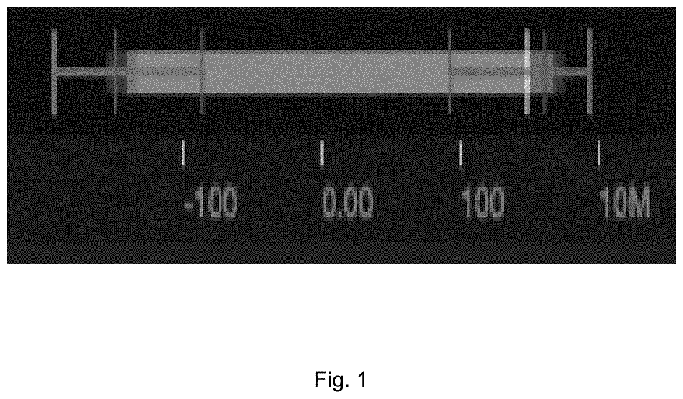

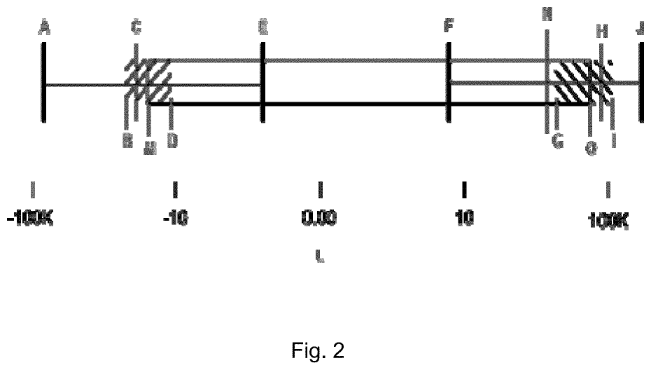

FIG. 1 illustrates a signed box and whisker plot displayed on a computer display according to certain example embodiments. FIG. 2 schematically illustrates more details and annotations of the plot shown in FIG. 1.

As shown in FIG. 1, the negative range and the positive range are plotted in two contrasting colors, whilst the overall range is plotted in a neutral color. For example, the negative range can be plotted in blue, the positive range in red, and the overall in gray. Of course, many combinations of colors and/or fill/thatch patterns can be used in accordance with the teachings of the example embodiments.

The FIGS. 1 and 2 show at least the following:

A to E: represents the negative range.

A: represents the blue vertical line at the start (left end) which is a representation of the smallest negative number. This is also the overall smallest number.

B to D: represents the blue horizontal bar which represents the first quartile to the third quartile of the negative numbers.

C: represents the second (from the left) blue vertical line which represents the median of the negative numbers.

E: represents the third (from the left) blue vertical line which represents the largest negative number.

M to O: represents the gray horizontal bar which represents the first and third quartiles of all (both positive and negative) numbers.

N: represents the gray vertical line which represents the median of the all (both positive and negative) numbers.

F to J: represents the positive range.

F: represents the first (from the left) red vertical line which represents the smallest positive number.

G to I: represents the smaller red horizontal bar which represents the first quartile to the third quartile of the positive numbers.

H: represents the second (from left) red vertical bar which represents the median of the positive numbers.

J: represents the last (from left) red vertical bar which represents the largest positive number. This is also the overall largest number.

L: represents the axis with ticks showing.

In some embodiments, the distinctive colors can be replaced by a set of respective line and/or fill patterns so that the three ranges can be distinguishably visually identified. Example line patterns may include variations in line thickness, dotted and/or dashed lines, dotted and/or dashed lines with varying spacing between dots/dashes and/or varying thickness of dots/dashes, etc. Example fill patterns may include different types of fill lines/characters/spacings/thicknesses etc. Some example embodiments may include combinations of variations of color, line patterns and/or fill patterns.

According to some example embodiments, the x-axis scale can be either a logarithmic scale or a linear scale. A linear or a logarithmic scale is picked based on the distribution of the numbers. If the distribution is closer to a normal distribution, a linear scale can be used, and if the distribution is closer to a log-normal distribution a logarithmic scale can be used. Also note that in the logarithmic scale the numbers between −1 to +1 are represented on a linear scale. The negative values less than −1 are plotted on a log scale of −x. This representation when the distribution is closer to a log-normal distribution provides a very clear visual representation of the distribution of financial numbers as, for example, payment information discussed above. Persons skilled in the art will understand that the example embodiments are particularly advantageous with respect to information such as payment information, some embodiments may not be advantageous for visualizing other data like physics experiment results.

Example embodiments are useful for visualizing many types of information. In accounting software data file/table store ledger entries that are both positive and negative in the same file/table. The credit and debit entries are entered as positive and negative numbers. The above graph of the example embodiments can provide for visualizing the positive debit entries and the negative credit entries on the same graph to get an understanding how numbers are spread.

In sales software applications, data file/table store sales entries and reversals of sales on the same file/table as positive entries for sales and negative entries for sales reversals. When sales are visualized according to some example embodiments, the sales ranges would are depicted by the positive entries and the sales reversals are depicted by the negative entries and both can be visualized at the same time.

In many software applications, like those described above, negative and positive numbers are stored in the same table. However, in real terms, the number range is just the positive numbers like the sales in the above example. When visualization is done it is important to get an understanding of both the negative numbers (which are often reversals of the positive numbers) and the positive numbers.

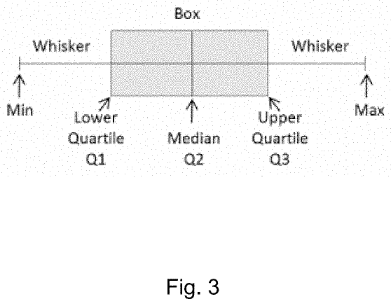

FIG. 3 illustrates a conventional graph technique for displaying data having negative and positive data. A box plot, box-and-whisker plot, boxplot are a convenient way of graphically depicting groups of numerical data through their quartiles. Box plots may also have lines extending vertically from the boxes (whiskers) indicating variability outside the upper and lower quartiles, hence the terms box-and-whisker plot and box-and-whisker diagram.

The spacing's between the different parts of the box (see e.g., FIG. 3) indicate the degree of dispersion (spread) and skewness in the data, and show outliers for the single range of data. If box plots are used to visualize three ranges of data, negative number range, complete number range and the positive number range three different box plots would have to be drawn on the display. In contrast to conventional techniques, the signed box and whisker plot technique of the example embodiments as described in this document represents all of the numbers on a single graph.

As in the example above, when a range of number from 6000 to 14000 also has one entry that is a reversal of 6000 given as −6000, some differences between the conventional techniques and the signed box and whisker technique of example embodiments are clearly illustrated. For example, as can be seen in relation to FIG. 3, in a conventional box plot, the illustrated range would be from −6000 to 14000. However, as can be seen in relation to FIGS. 1 and 2, in a signed box and whisker plot all of the ranges can be visualized at the same time.

The capability to separately illustrate detailed information (e.g., mean, median, average, quartiles, highest number, lowest number etc.,) about the different number ranges (e.g., negative numbers only, positive numbers only, all numbers, etc.) in the same plot provides for quicker and more accurate examination and comparison of numbers for various purposes such as, for example, audit purposes. The single plot including all different ranges optimizes the display space available on an electronic display, and thus improves upon the display of the information. Such single plots may also enable more efficient use of dashboard space, such as, web-based dashboards used for monitoring financial or other activity, and thus enable more efficient and effective monitoring of transactions. Moreover, in addition to advantages in the use of screen space, example embodiments may also provide advantages in reducing digital storage space by, instead of storing the information for three separate graphs, storing information only for a single graph.

The displaying of the signed box and whisker plot according to embodiments may be preceded by electronically accessing a single memory storage or distributed memory storage to retrieve data (e.g., the payment and reversal data records) from one or more database tables stored in the memory. The accessing of the data, and the subsequent processing of the retrieved data to generate and output the plot may be controlled by one or more computer programs executed by one or more computers. The one or more computer programs may be stored in a non-volatile memory or computer readable medium such as a flash memory, CD, hard disk, optical disc, magnetic disc or other storage device. The retrieved data may be processed to identify the different ranges by, for example, forming a first group including only the records with negative values in a selected field, a second group including only the records with positive values in the selected field, and a third group which may be the aggregation of the first and second groups. Some embodiments may optimize the computer memory by separately storing the records only for the first and second groups, and automatically aggregating the records when the plot is being displayed on a display attached to the computer and/or when the plot is being generated for output to a printer or storage. After the records are grouped, the plot generation may occur. The computer system may be configured to automatically select the color scheme and/or other representation scheme to be used in the plot based upon the type of data, the values to be represented (e.g., maximum range, etc.), and/or the type of display/printer to which the plot is to be output.

The techniques described herein are capable of being used in environments with any numbers of digitally stored records (e.g., hundreds of millions of records) and may be effectively used to visualize constantly changing data too. For example, a computer program may periodically retrieve data records from distributed databases to obtain a series of snapshots of payment records, may sort each snapshot into the different ranges and calculate the parameters for each of the different ranges to generate the signed box and whisker plot.

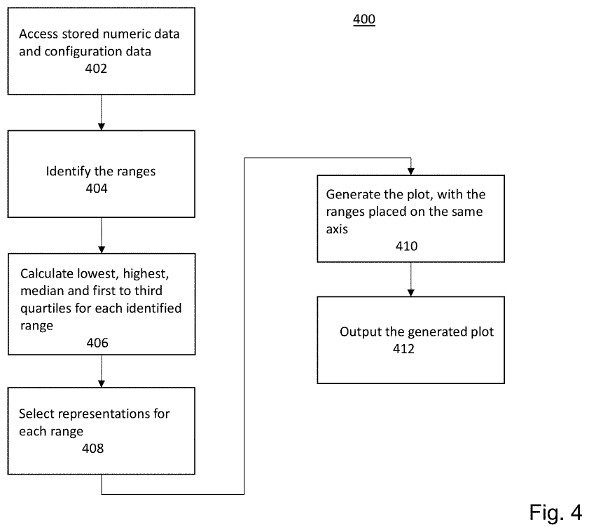

FIG. 4 illustrates a process 400 for displaying a plot describing a data set, according to some example embodiments. The process 400 may be performed by a processing system having at least one processor, and some of the operations may be performed in an order different from that shown in FIG. 4. Process 400 may be triggered, for example, when a user (e.g. human analyst, computer program) issues an instruction to plot a collection of numeric data.

After entering process 400, at operation 402, the numeric data and configuration information for the plot are accessed. The numeric data and configuration information may be stored in any type of digital storage in one or more storage locations. The numeric data accessed may include one or more of negative numbers and positive numbers.

The configuration information may indicate the type of plot, a default scale for the plot, default colors/patterns for the plot, and the like.

At operation 404, the accessed numeric data is analyzed to identify three groups: a first group of only negative numbers, a second group of only positive numbers, and a third group of all the accessed numbers (i.e. aggregation of the first group and the second group).

At operation 406, for each group, the lowest value, the highest value, the first to third quartiles, and the median, are determined. For the third group, the lowest and highest values may not be separately determined, because the lowest value for the third group is also the lowest value for the first group, and the highest value for the third group is also the highest value of the second group.

At operation 408, representation colors and/or patterns are selected for each of the three ranges. According to some embodiments, the three ranges are represented with respectively different colors and/or patterns so that they are clearly distinguishable from each other based on the unique set of colors and/or patterns selected for each. In some embodiments, one or more ranges may be represented with a color and/or pattern scheme that overlaps partly or entirely with another of the ranges.

At operation 410, the plot is generated by illustrating the three ranges in on the same axis. In some embodiments, the ranges are placed on the same horizontal axis to generate a graph such as the shown in FIG. 1 or 2. The generated plot is referred to as a signed box and whisker plot, and may be considered comprising respective box and whisker plots for each of the negative numbers group, the positive numbers group and the aggregated group, with the aggregated group's box and whiskers plot partially overlapping the other two box and whisker plots.

At operation 412, the generated plot is output. According to some embodiments, the generated plot is displayed on a display screen. The displayed plot may be generated with a size adapted to the size of the display screen, the display window, and/or other display area in which the plot is to be displayed. It should be noted however that the plot may be output by means in addition to, or other than, displaying, such as, for example, transmitting the plot to another computer, storing the generated plot to a digital storage, printing the plot, or the like.

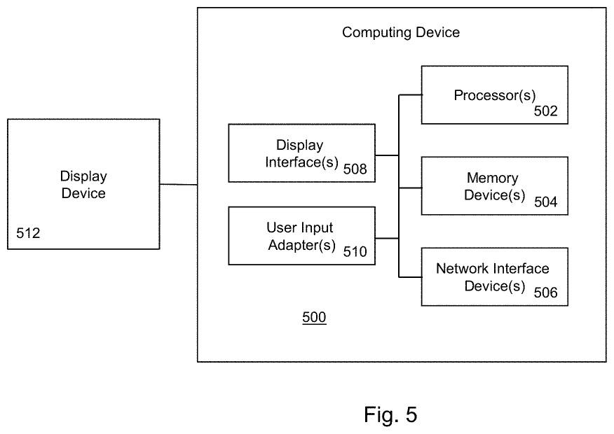

FIG. 5 schematically illustrates a computer that can be used to implement the novel numeric data plotting technique, according to some example embodiments. FIG. 5 is a block diagram of an example computing device 500 (which may also be referred to, for example, as a “computing device,” “computer system,” or “computing system”) according to some embodiments. In some embodiments, the computing device 500 includes one or more of the following: one or more processors 502; one or more memory devices 504; one or more network interface devices 506; one or more display interfaces 508; and one or more user input adapters 510. Additionally, in some embodiments, the computing device 500 is connected to or includes a display device 512. As will explained below, these elements (e.g., the processors 502, memory devices 504, network interface devices 506, display interfaces 508, user input adapters 510, display device 512) are hardware devices (for example, electronic circuits or combinations of circuits) that are configured to perform various different functions for the computing device 500.

In some embodiments, each or any of the processors 502 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like).

In some embodiments, each or any of the memory devices 504 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 502). Memory devices 504 are examples of non-volatile computer-readable storage media.

In some embodiments, each or any of the network interface devices 1306 includes one or more circuits (such as a baseband processor and/or a wired or wireless transceiver), and implements layer one, layer two, and/or higher layers for one or more wired communications technologies and/or wireless communications technologies.

In some embodiments, each or any of the display interfaces 508 is or includes one or more circuits that receive data from the processors 502, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 512, which displays the image data. Alternatively or additionally, in some embodiments, each or any of the display interfaces 508 is or includes, for example, a video card, video adapter, or graphics processing unit (GPU).

In some embodiments, each or any of the user input adapters 510 is or includes one or more circuits that receive and process user input data from one or more user input devices that are included in, attached to, or otherwise in communication with the computing device 500, and that output data based on the received input data to the processors 502. Alternatively or additionally, in some embodiments each or any of the user input adapters 510 is or includes, for example, a PS/2 interface, a USB interface, a touchscreen controller, or the like; and/or the user input adapters 510 facilitates input from user input devices such as, for example, a keyboard, mouse, trackpad, touchscreen, etc.

In some embodiments, the display device 512 may be a Liquid Crystal Display (LCD) display, Light Emitting Diode (LED) display, or other type of display device. In embodiments where the display device 512 is a component of the computing device 500 (e.g., the computing device and the display device are included in a unified housing), the display device 512 may be a touchscreen display or non-touchscreen display. In embodiments where the display device 512 is connected to the computing device 500 (e.g., is external to the computing device 500 and communicates with the computing device 500 via a wire and/or via wireless communication technology), the display device 512 is, for example, an external monitor, projector, television, display screen, etc.

In various embodiments, the computing device 500 includes one, or two, or three, four, or more of each or any of the above-mentioned elements (e.g., the processors 502, memory devices 504, network interface devices 506, display interfaces 508, and user input adapters 510). Alternatively or additionally, in some embodiments, the computing device 500 includes one or more of: a processing system that includes the processors 502; a memory or storage system that includes the memory devices 504; and a network interface system that includes the network interface devices 506.

As previously noted, whenever it is described in this document that a software module or software process performs any action, the action is in actuality performed by underlying hardware elements according to the instructions that comprise the software module.

The hardware configurations shown in FIG. 5 and described above are provided as examples, and the subject matter described herein may be utilized in conjunction with a variety of different hardware architectures and elements.

What is claimed is:

1. A computer-implemented method of generating a range of numbers that includes both positive and negative numbers, the method comprising:
accessing in a digital storage, by at least one processor, numeric data that includes both positive and negative numbers;
identifying, by the at least one processor, a first group of negative numbers only and a second group of positive numbers only from the accessed numeric data;
calculating, by the least one processor, at least a lowest value, a highest value, a median value, and a first to third quartile of values in each of the first group, the second group and a third group, wherein the third group includes an aggregation of the first group and the second group;
generating a plot with the first group, the second group and the third group arranged on a same axis, wherein the calculated median value and the calculated first to third quartile of values identified in the plot for the first, second and third groups, and wherein the calculated lowest value and the calculated highest value are identified in the plot for at least the first group and the second group; and
outputting the generated plot.

2. The computer-implemented method according to claim 1, wherein the method further comprises selecting a respective representation scheme for each of the first, second and third groups, and wherein the outputting comprises displaying the generated plot with each of the first, second and third groups displayed in accordance with the selected respective representation scheme.

3. The method according to claim 2, wherein each of the respective representation schemes is unique.

4. The method according to claim 1, wherein the plot comprises first, second and third box-and-whisker plots arranged such that the first and third box-and-whisker plots partially overlap and the third and second box-and-whisker plots partially overlap.

5. The method according to claim 4, wherein the first, second, and third box-and-whisker plots correspond respectively to the first group, the second group and the third group.

6. The method according to claim 5, wherein the generated plot including the first, second and third box-and-whisker plots is arranged in a form of one box-and-whisker plot.

7. The method according to claim 1, wherein the first to third quartiles for the first and third groups are arranged to partially overlap, and the first to third quartiles for the third and second groups are arranged to partially overlap.

8. A system including at least one processor, a memory, and a digital output device, wherein the at least one processor is configured to perform operations including:
accessing in the memory, numeric data that includes both positive and negative numbers;
identifying a first group of negative numbers only and a second group of positive numbers only from the accessed numeric data;
calculating at least a lowest value, a highest value, a median value, and a first to third quartile of values in each of the first group, the second group and a third group, wherein the third group includes an aggregation of the first group and the second group;
generating a plot with the first group, the second group and the third group arranged on a same axis, wherein the calculated median value and the calculated first to third quartile of values identified in the plot for the first, second and third groups, and wherein the calculated lowest value and the calculated highest value are identified in the plot for at least the first group and the second group; and
outputting the generated plot to the digital output device.

9. The system according to claim 8, wherein the operations further comprise selecting a respective representation scheme for each of the first, second and third groups, wherein the outputting comprises displaying the generated plot with each of the first, second and third groups displayed in accordance with the selected respective representation scheme.

10. The system according to claim 9, wherein each of the respective representation schemes is unique.

11. The system according to claim 8, wherein the plot comprises first, second and third box-and-whisker plots arranged such that the first and third box-and-whisker plots partially overlap and the third and second box-and-whisker plots partially overlap.

12. The system according to claim 11, wherein the first, second, and third box-and-whisker plots correspond respectively to the first group, the second group and the third group.

13. The system according to claim 12, wherein the generated plot including the first, second and third box-and-whisker plots is arranged in a form of one box-and-whisker plot.

14. The system according to claim 8, wherein the first to third quartiles for the first and third groups are arranged to partially overlap, and the first to third quartiles for the third and second groups are arranged to partially overlap.

15. A non-transitory computer readable storage medium storing program instructions which, when executed by a processing system comprising at least one processor, causes the processing system to perform operations comprising:
accessing in a digital storage device, numeric data that includes both positive and negative numbers;
identifying a first group of negative numbers only and a second group of positive numbers only from the accessed numeric data;
calculating at least a lowest value, a highest value, a median value, and a first to third quartile of values in each of the first group, the second group and a third group, wherein the third group includes an aggregation of the first group and the second group;
generating a plot with the first group, the second group and the third group arranged on a same axis, wherein the calculated median value and the calculated first to third quartile of values identified in the plot for the first, second and third groups, and wherein the calculated lowest value and the calculated highest value are identified in the plot for at least the first group and the second group; and
outputting the generated plot.
